(19) United States
(12) Patent Application Publication
(10) Pub. No.: US 2026/0307601 A1
(43) Pub. Date: Oct. 8, 2026

(54) WIRING HARNESS

(71) Applicant: Sumitomo Wiring Systems, Ltd., Yokkaichi-shi (JP)

(72) Inventors: Takashi KAMBE, Yokkaichi-shi (JP); Go UENO, Yokkaichi-shi (JP); Miyu MIZUTANI, Yokkaichi-shi (JP); Mitsuhiro SHIMAMURA, Yokkaichi-shi (JP)

(73) Assignee: Sumitomo Wiring Systems, Ltd., Yokkaichi-shi (JP)

(21) Appl. No.: 19/639,595

(22) Filed: Apr. 6, 2026

(30) Foreign Application Priority Data
Apr. 4, 2025 (JP) 2025-062500

(51) Int. Cl. B60R 16/02; B60J 5/06

(52) U.S. Cl. CPC B60R 16/0207; B60J 5/06

(57) ABSTRACT

A wiring harness including: a wire group that is configured to be routed from a vehicle body to a sliding door that is openable and closeable with respect to the vehicle body; and a plurality of separate carriers that cover the wire group with the separate carriers rotatably coupled to each other and arranged adjacently along a coupling axis parallel to a direction in which the wire group extends.

### BACKGROUND

The present disclosure relates to a wiring harness.

Conventionally, wiring harnesses are provided with a wire group that is routed from a vehicle body to a sliding door that is openable and closeable with respect to the vehicle body, and a plurality of separate carriers that cover the wire group (e.g., see JP 2021-145512A). The separate carriers are rotatably coupled to each other and arranged adjacently along a coupling axis parallel to the direction in which the wire group extends, thereby allowing the wire group to bend while protecting the wire group.

These separate carriers each have a separate carrier body and a carrier cover. The separate carrier body is formed in a U-shape that is open along a coupling intersecting axis that intersects the coupling axis and has a locking claw that protrudes along the coupling intersecting axis. The carrier cover has a locking hole in which the locking claw is locked when passed therethrough. The locking claw is passed through the locking hole due to the carrier cover being moved along the coupling intersecting axis relative to the separate carrier body. The carrier cover is thereby fixed to the separate carrier body and the opening in the separate carrier body is blocked.

### SUMMARY

However, with the above wiring harness, the carrier cover is fixed due to the locking claw catching inside the locking hole, and thus there is a problem in that the carrier cover tends to be loose in a direction along the coupling intersecting axis with respect to the separate carrier body. Note that this, for example, causes the carrier cover to vibrate against the separate carrier body, which in turn causes abnormal noise.

An exemplary aspect of the disclosure provides a wiring harness capable of suppressing looseness of a carrier cover in a direction along a coupling intersecting axis.

A wiring harness of the present disclosure is a wiring harness including a wire group routed from a vehicle body to a sliding door openable and closeable with respect to the vehicle body, and a plurality of separate carriers covering the wire group and rotatably coupled to each other and arranged adjacently along a coupling axis parallel to a direction in which the wire group extends, the separate carriers each including a U-shaped separate carrier body open along a coupling intersecting axis intersecting the coupling axis due to having a back wall and a pair of side walls opposing each other and extending from both ends of the back wall, and a carrier cover having a plate-shaped part that blocks an opening of the separate carrier body, the separate carrier body having an engaged part on each of the side walls, and the carrier cover having an engaging part that is fixed by being slid along the coupling axis with respect to the engaged part.

According to the wiring harness of the present disclosure, looseness of the carrier cover in the direction along the coupling intersecting axis can be suppressed.

### BRIEF DESCRIPTION OF THE DRAWINGS

FIG. 1 is a schematic diagram from above showing part of a vehicle in which a sliding door is fully closed in one embodiment;

FIG. 2 is a schematic diagram from above showing part of the vehicle during operation of the sliding door in one embodiment;

FIG. 3 is a schematic diagram from above showing part of the vehicle in which the sliding door is fully open in one embodiment;

FIG. 4 is a partially exploded perspective view of a wiring harness in one embodiment;

FIG. 5 is a plan view for describing the types of separate carriers in one embodiment;

FIG. 6 is a plan view for describing the types of separate carriers in one embodiment;

FIG. 7 is an exploded perspective view of the separate carrier in one embodiment;

FIG. 8 is an exploded perspective view of the separate carrier in one embodiment;

FIG. 9 is an exploded plan view of the separate carrier in one embodiment;

FIG. 10 is a partially enlarged plan view of the separate carrier in one embodiment;

FIG. 11 is a cross-sectional view taken along line 11-11 in FIG. 10; and

FIG. 12 is a partially enlarged plan view of the separate carrier in another example.

### EMBODIMENTS OF THE DISCLOSURE

### Description of Embodiments of the Disclosure

Initially, modes of the present disclosure will be enumerated and described.

[1] A wiring harness of the present disclosure is a wiring harness including a wire group routed from a vehicle body to a sliding door openable and closeable with respect to the vehicle body, and a plurality of separate carriers covering the wire group and rotatably coupled to each other and arranged adjacently along a coupling axis parallel to a direction in which the wire group extends, the separate carriers each including a U-shaped separate carrier body open along a coupling intersecting axis intersecting the coupling axis due to having a back wall and a pair of side walls opposing each other and extending from both ends of the back wall, and a carrier cover having a plate-shaped part that blocks an opening of the separate carrier body, the separate carrier body having an engaged part on each of the side walls, and the carrier cover having an engaging part that is fixed by being slid along the coupling axis with respect to the engaged part.

According to this configuration, the carrier cover has an engaging part that is fixed by being slid along the coupling axis with respect to the engaged part of the separate carrier body, thus enabling looseness in the direction along the coupling intersecting axis to be suppressed. That is, with a configuration in which the separate carrier body has a locking claw that protrudes along the coupling intersecting axis and is locked in a locking hole of the carrier cover, for example, the carrier cover tends to be loose in the direction along the coupling intersecting axis, but compared thereto, such looseness can be made less likely.

[2] In [1] above, the engaged part may include an insertion recessed part recessed from an outer side along a parallel arrangement axis on which the pair of side walls are arranged and extending along the coupling intersecting axis from a distal end of each of the side walls, and a sliding recessed part extending along the coupling axis from the insertion recessed part in a bending manner, and the engaging part may include an insertion raised part protruding from the plate-shaped part in a manner insertable into the insertion recessed part, and a fitting raised part extending along the coupling axis from the insertion raised part in a manner fittable into the sliding recessed part.

According to this configuration, the carrier cover is fixed to the separate carrier body due to the insertion raised part being inserted into the insertion recessed part along the coupling intersecting axis, and, further, the fitting raised part being fitted into the sliding recessed part along the coupling axis. With this configuration, given that the fitting raised part is fitted in the sliding recessed part along the coupling axis, looseness of the carrier cover in the direction along the coupling intersecting axis can be suppressed.

[3] In [2] above, the insertion raised part may have an inclined surface that is distanced further from a bottom surface of the insertion recessed part proceeding toward a distal end thereof.

According to this configuration, the insertion raised part has an inclined surface that is distanced further from the bottom surface of the insertion recessed part proceeding toward the distal end thereof, thus facilitating the task of inserting the insertion raised part into the insertion recessed part. That is, catching of the insertion raised part when inserting the insertion raised part into the insertion recessed part can be suppressed due to the inclined surface.

[4] In any one of [1] to [3] above, the carrier cover may have a pair of inner walls respectively opposing inner surfaces of the pair of side walls.

According to this configuration, the carrier cover has a pair of inner walls respectively opposing the inner surfaces of the pair of side walls, and thus, for example, excessive looseness of the carrier cover in the direction along the parallel arrangement axis on which the pair of side walls are arranged can be suppressed.

[5] In [1] above, the engaged part may include an insertion recessed part recessed from an outer side along a parallel arrangement axis on which the pair of side walls are arranged and extending along the coupling intersecting axis from a distal end of each of the side walls, and a sliding recessed part extending along the coupling axis from the insertion recessed part in a bending manner, and the engaging part may include an insertion raised part protruding from the plate-shaped part in a manner insertable into the insertion recessed part, and a fitted raised part extending along the coupling axis from the insertion raised part, with a residual wall formed between a distal end of each of the side walls and the sliding recessed part being fittable between the fitted raised part and the plate-shaped part.

According to this configuration, the carrier cover is fixed to the separate carrier body due to the insertion raised part being inserted into the insertion recessed part along the coupling intersecting axis, and, further, the residual wall formed between the distal end of each of the side walls and the sliding recessed part being fitted between the fitted raised part and the plate-shaped part. With this configuration, given that the residual wall is fitted between the fitted raised part and the plate-shaped part along the coupling axis, looseness of the carrier cover in the direction along the coupling intersecting axis can be suppressed.

### Detailed Description of Embodiments of the Disclosure

Specific examples of a wiring harness of the present disclosure will be described below with reference to the drawings. In the diagrams, part of the configuration may be shown in an exaggerated or simplified manner for convenience of description. Also, the dimensional ratios of various portions may differ in the diagrams.

The term “orthogonal” herein includes not only strictly orthogonal but also generally orthogonal within a range that achieves the operation and effect of the present embodiment.

The term “tubular” used herein includes not only members whose peripheral wall is formed continuously around the entire circumference thereof, but also members that combine a plurality of components to form a tubular shape, and members that have a cutout or the like in part thereof in the circumferential direction such as a C-shape. A “tubular” outer peripheral shape includes, but is not limited to, circular and oval shapes and polygonal shapes with pointed or rounded corners. The term “tubular” refers to a shape having a through hole in plan view, and includes members whose outer peripheral shape is the same as the inner circumference shape of the through hole, and members whose outer peripheral shape is different from the inner circumference shape of the through hole. The term “tubular” includes members having a predetermined length extending in an axial direction in which a central axis thereof that passes through the center of the through hole extends, regardless of the relative lengths of the members.

The term “opposing” herein means that surfaces or members are positioned in front of each other, and includes not only the case where the portions are perfectly in front of each other but also the case where the portions are partially in front of each other. Also, “opposing” herein includes both the case where there is another member interposed between the two portions, and the case where there is no other member interposed between the two portions.

Terms such as “first” and “second” herein are used simply to distinguish between objects and do not rank the objects. The present disclosure is not limited to these illustrative examples and is indicated by the claims, and all changes that come within the meaning and range of equivalency of the claims are intended to be embraced therein.

### Configuration of Wire Harness 20

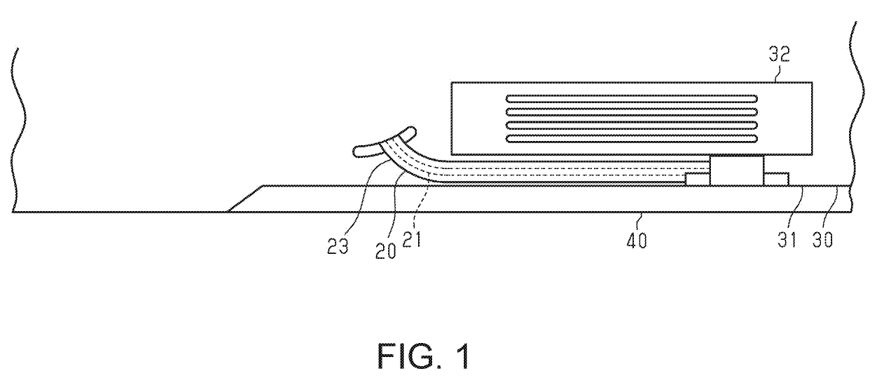

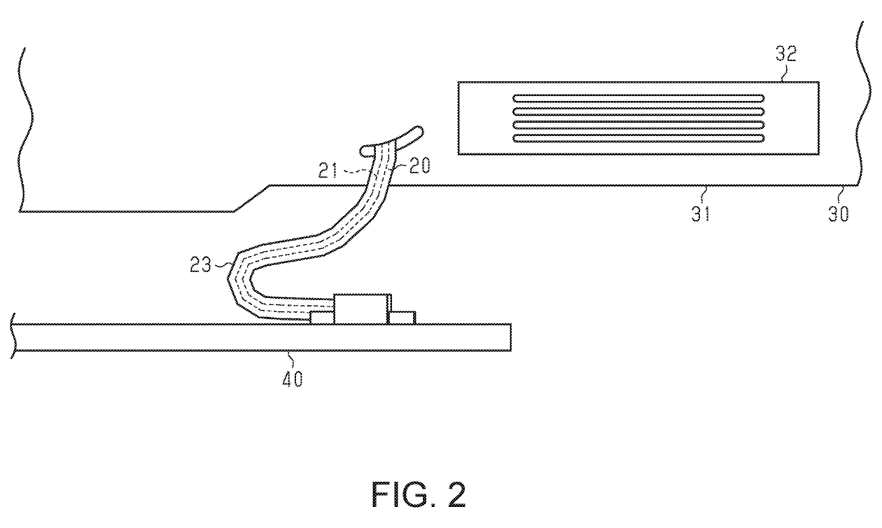

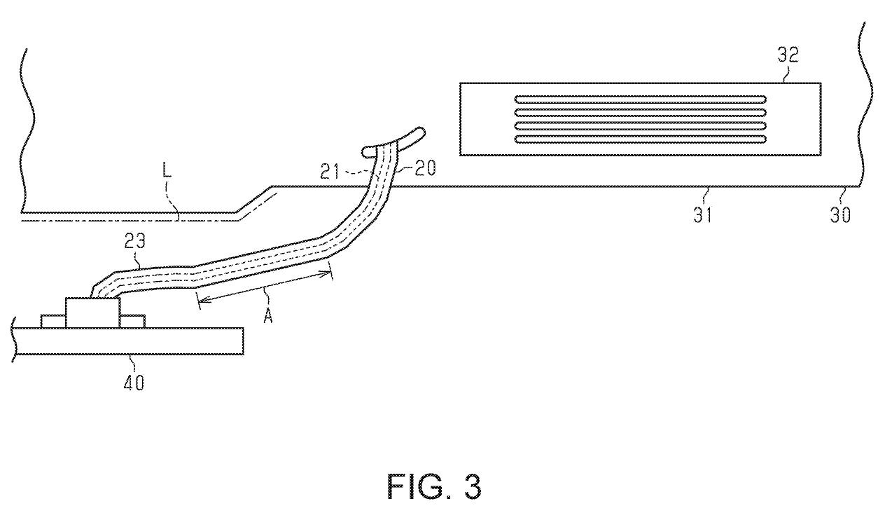

As shown in FIGS. 1 to 3, a wiring harness 20 is provided with a wire group 21 that is routed from a vehicle body 30 to a sliding door 40 of a vehicle. The wire group 21 electrically connects a power control device (not shown) provided in the vehicle body 30 to electrical devices (not shown) provided in the sliding door 40. Note that the electrical devices are, for example, a power window motor, a lock actuator, and the like, and the power control device is a device for supplying power to those electrical devices. The vehicle body 30 has an opening 31 that is openable and closeable by the sliding door 40. Also, the vehicle body 30 is provided with a running board 32. The running board 32 is provided in a region corresponding to the sliding door 40 on the vehicle inner side (upper side in FIG. 1) with respect to an edge portion of the vehicle outer side (lower side in FIG. 1) of the opening 31. The running board 32 is where users place their feet when getting in and out of the vehicle. Also, the sliding door 40 is provided in a manner slidable in a front-back direction (right-left direction in FIG. 1) of the vehicle body 30 by a mechanism (not shown). Specifically, the sliding door 40 is movable to the vehicle outer side (lower side in FIG. 1) of the vehicle body 30 from a fully closed state (see FIG. 1) while being slid in a rearward direction (leftward direction in FIG. 2) of the vehicle body 30 to a fully open state (FIG. 3) by the mechanism (not shown).

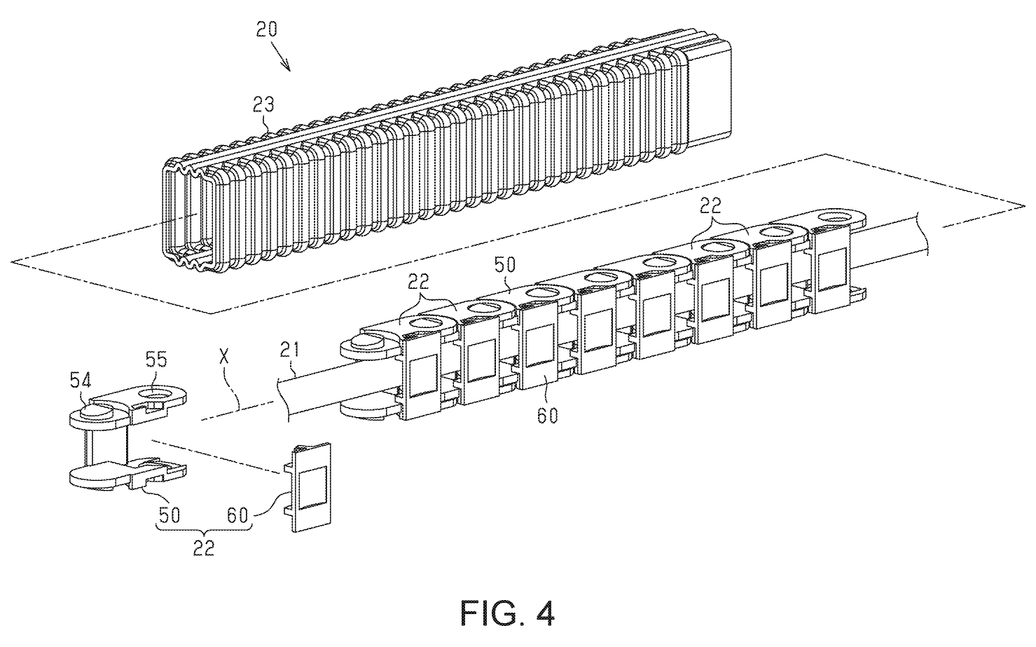

As shown in FIG. 4, the wiring harness 20 is provided with the wire group 21, the separate carriers 22, and a rubber boot 23. Note that FIG. 4 shows part of the wiring harness 20 with one separate carrier 22 and the rubber boot 23 in an exploded state. Also, the wire group 21 is constituted by a plurality of wires bundled together but is shown schematically in the diagram and illustration of the individual wires is omitted.

### Configuration of Separate Carriers 22

The separate carriers 22 are made of a resin material.

The separate carriers 22 cover the wire group 21 and are rotatably coupled to each other and arranged adjacently along a coupling axis X that is parallel to the direction in which the wire group 21 extends. Note that the coupling axis X referred to here is an axis along the wire group 21 extended in a straight state.

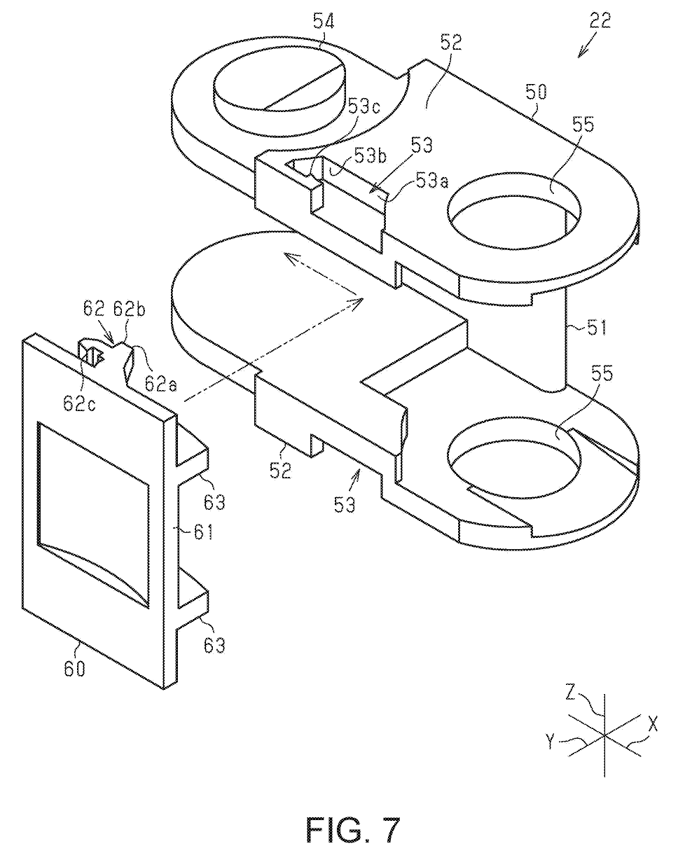

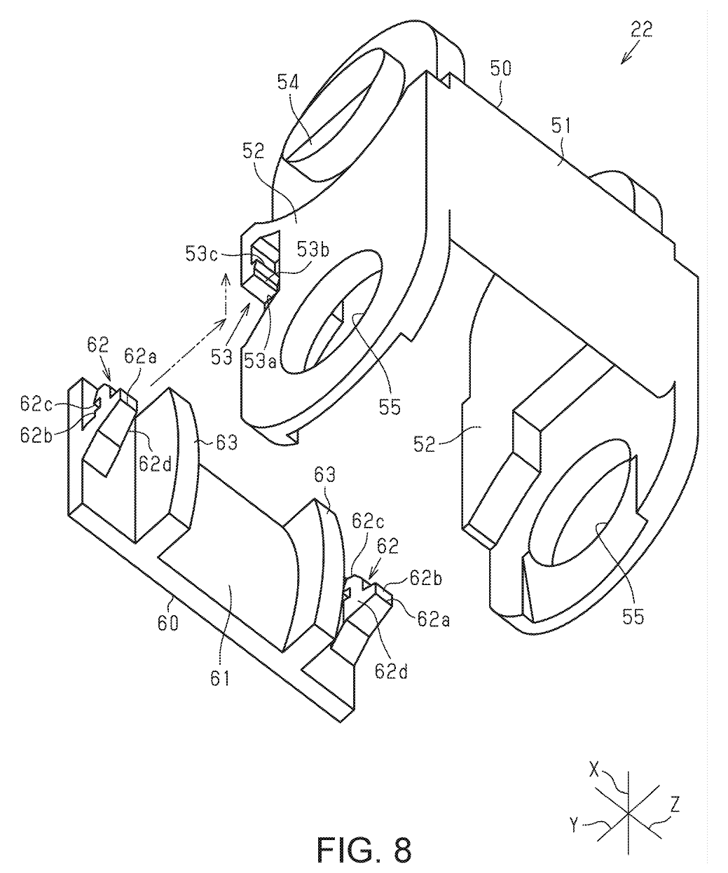

As shown in FIGS. 7 and 8, the separate carriers 22 each have a separate carrier body 50 and a carrier cover 60. Note that the diagrams show the coupling axis X, a coupling intersecting axis Y that intersects the coupling axis X and is orthogonal to the coupling axis X, and a parallel arrangement axis Z that is orthogonal to the coupling axis X and the coupling intersecting axis Y.

The separate carrier body 50 is formed in a U-shape that is open along the coupling intersecting axis Y due to having a back wall 51 and a pair of side walls 52 that extend from both ends of the back wall 51. In other words, the separate carrier body 50 is formed in a U-shape when viewed along the coupling axis X.

Also, the carrier cover 60 has a plate-shaped part 61 that blocks the opening of the U-shaped separate carrier body 50 when fixed to the separate carrier body 50. That is, the carrier cover 60 has the plate-shaped part 61 disposed so as to join the distal ends of the side walls 52.

The separate carrier body 50 has an engaged part 53 on each of the side walls 52. The carrier cover 60 has an engaging part 62 that is fixed by being slid along the coupling axis X with respect to the engaged part 53.

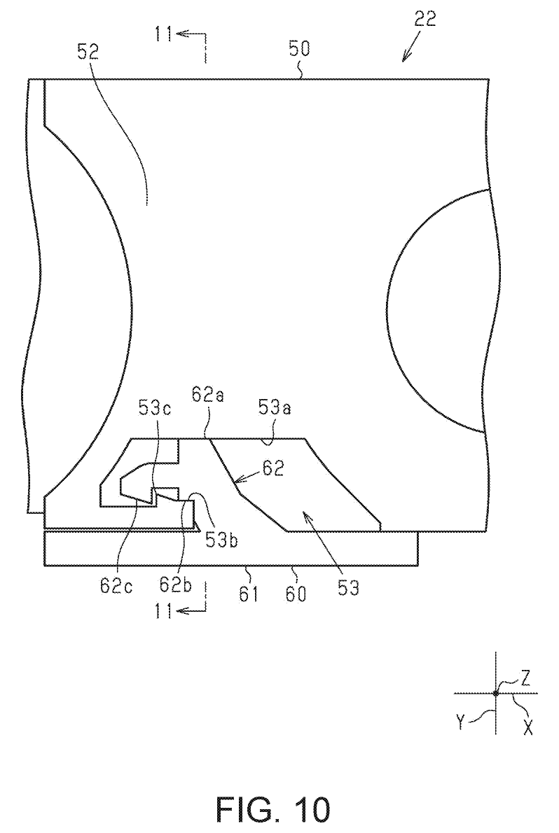

Specifically, the engaged part 53 is recessed from the outer side of each of the side walls 52 along the parallel arrangement axis Z on which the pair of side walls 52 are arranged. The engaged part 53 has an insertion recessed part 53a that extends along the coupling intersecting axis Y from the distal end of each of the side walls 52, and a sliding recessed part 53b that extends along the coupling axis X from the insertion recessed part 53a in a bending manner. Also, a locking claw part 53c is formed in the sliding recessed part 53b. The locking claw part 53c of the present embodiment is formed protruding from the surface of the sliding recessed part 53b on the distal end side (lower side in FIG. 10) of the side wall 52.

The engaging part 62 has an insertion raised part 62a that protrudes in a manner insertable into the insertion recessed part 53a along the coupling intersecting axis Y from the plate-shaped part 61 and a fitting raised part 62b that extends along the coupling axis X from the insertion raised part 62a in a manner insertable into the sliding recessed part 53b. Also, a locked claw part 62c that is lockable onto the locking claw part 53c is formed in the fitting raised part 62b. The locked claw part 62c of the present embodiment is formed protruding further along the coupling axis X from the distal end of the fitting raised part 62b in a manner lockable onto the locking claw part 53c.

Note that the fitting raised part 62b of the present embodiment is set such that there is zero gap with the sliding recessed part 53b along the coupling intersecting axis Y. That is, the width of the fitting raised part 62b along the coupling intersecting axis Y is set to be the same as the width of the sliding recessed part 53b along the coupling intersecting axis Y.

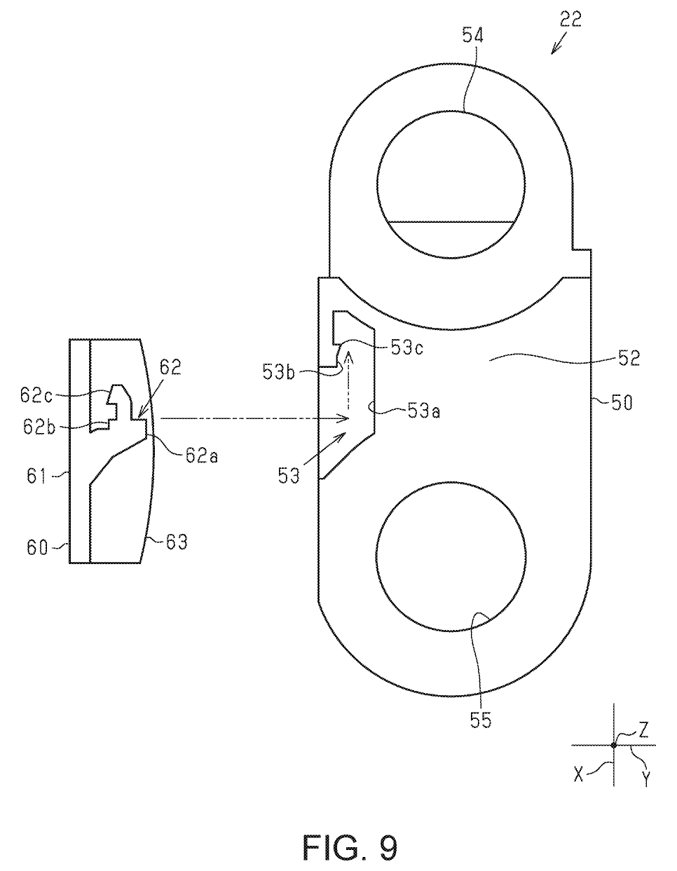

As shown in FIGS. 9 and 10, the carrier cover 60 of the present embodiment is fixed to the separate carrier body 50 by first being moved along the coupling intersecting axis Y and, thereafter, being slid along the coupling axis X with respect to the separate carrier body 50.

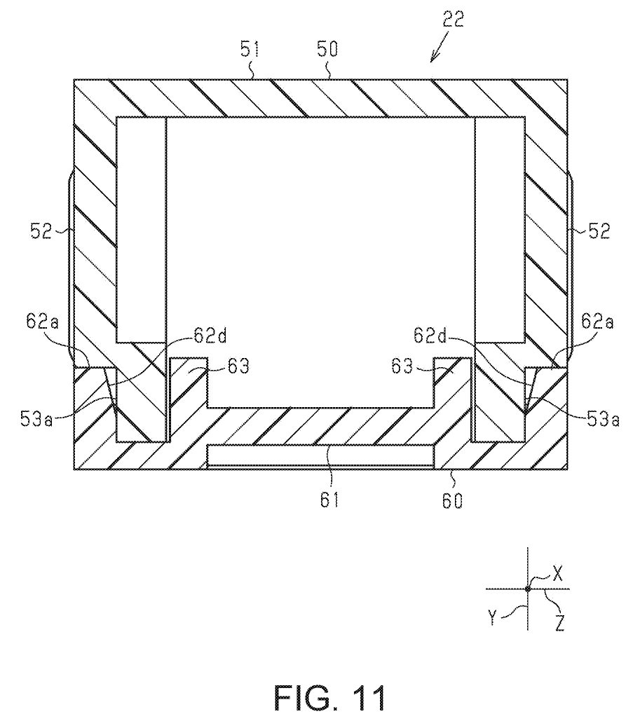

Also, as shown in FIGS. 8 and 11, the insertion raised part 62a has an inclined surface 62d that is distanced further from the bottom surface of the insertion recessed part 53a proceeding toward to the distal end thereof. Note that the inclined surface 62d of the present embodiment is formed as a single flat surface that spans from the insertion raised part 62a to the fitting raised part 62b.

Also, the carrier cover 60 has a pair of inner walls 63 that respectively oppose inner surfaces of the pair of side walls 52 in the separate carrier body 50. As shown in FIG. 8, the pair of inner walls 63 of the present embodiment are formed to span the entire width of the plate-shaped part 61 of the carrier cover 60 along the coupling axis X.

Also, as shown in FIG. 7, the separate carrier body 50 has a rotating shaft part 54 at a first end portion thereof along the coupling axis X, and a rotated shaft part 55 to which the rotating shaft part 54 is couplable at a second end portion thereof. The rotating shaft part 54 protrudes along the parallel arrangement axis Z from the outer surface of each of the side walls 52. Also, the rotated shaft part 55 is a hole that passes through each of the side walls 52. The separate carrier bodies 50 are each rotatable relative to another separate carrier body 50 adjacent thereto, due to the rotating shaft part 54 being rotatably coupled to the rotated shaft part 55 in the other separate carrier body 50 adjacent thereto.

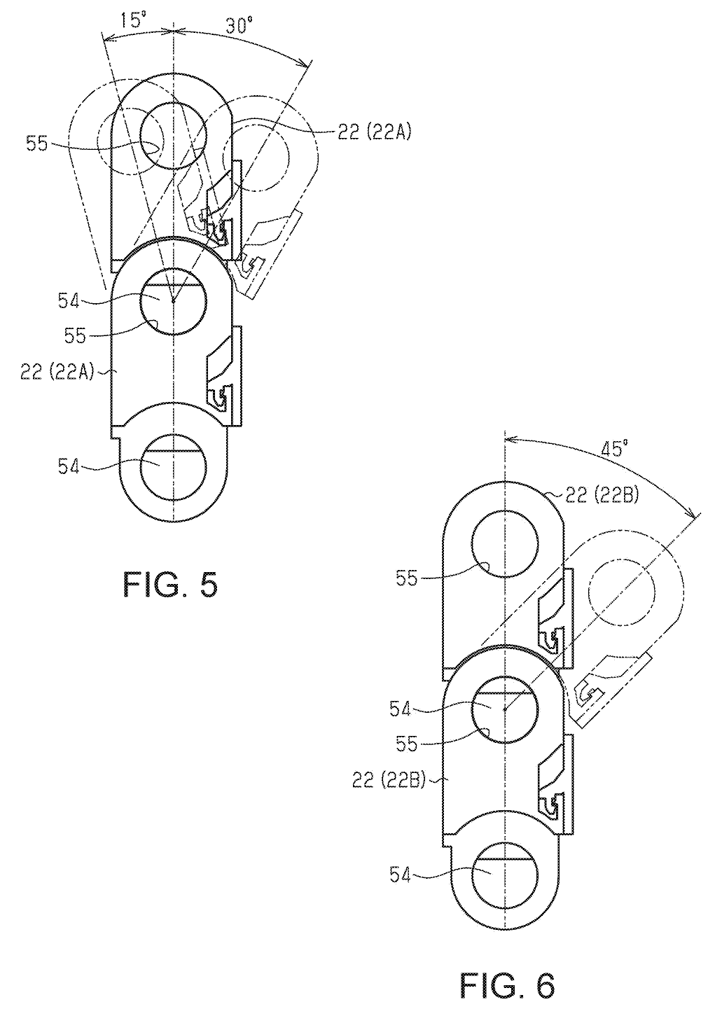

As shown in FIGS. 5 and 6, there are two types of separate carriers 22 of the present embodiment, namely, a first separate carrier 22A (see FIG. 5) and a second separate carrier 22B (see FIG. 6), with different rotatable angles. As shown in FIG. 5, the first separate carrier 22A is rotatable 15 degrees counterclockwise, in the diagram, in a first rotation direction from a straight state, and is rotatable 30 degrees clockwise, in the diagram, in a second rotation direction from the straight state. Also, as shown in FIG. 6, the second separate carrier 22B is not rotatable counterclockwise, in the diagram, in the first rotation direction from a straight state, and is rotatable 45 degrees clockwise, in the diagram, in the second rotation direction from the straight state. Note that the rotatable angle of the separate carriers 22 is set by a known structure that changes the shape of the region that engages an adjacent separate carrier 22 (not shown).

The first separate carriers 22A and the second separate carriers 22B constituting the separate carriers 22 are combined in such a manner as to ensure that the wiring harness 20 does not protrude to the vehicle body 30 side (upper side in FIG. 3) beyond a protrusion prevention line L (see FIG. 3). Note that the protrusion prevention line L is a line that is set for each vehicle model, so that a certain distance is maintained from the vehicle body 30 along the vehicle body 30, for example.

As shown in FIG. 3, for example, in the present embodiment, the second separate carrier 22B (see FIG. 6) is employed in an intermediate range A of the wiring harness 20. The wiring harness 20 is thereby prevented from protruding to the vehicle body 30 side (upper side in FIG. 3) beyond the protrusion prevention line L. Therefore, the wiring harness 20 is prevented from hitting against the vehicle body 30. Note that the first separate carrier 22A (see FIG. 5) is employed in ranges of the wiring harness 20 other than the intermediate range A. Also, the combination of the first separate carriers 22A and the second separate carriers 22B may, of course, be changed as appropriate according to the protrusion prevention line L set for each vehicle model and the like, for example.

### Configuration of Rubber Boot 23

The rubber boot 23 is made of a rubber material.

As shown in FIG. 4, the rubber boot 23 is provided so as to cover the separate carriers 22 coupled rotatably. The rubber boot 23 is formed in a tubular shape and has a bellows structure constituted by alternating recessed and raised portions in the extension direction. The rubber boot 23 is formed in a manner readily bendable due to the bellows structure and allows for rotation of the separate carriers 22.

### Operation of the Embodiment

Next, operation of the wiring harness 20 configured as described above will be described.

As shown in FIGS. 9 and 10, when the carrier cover 60 is first moved along the coupling intersecting axis Y and, thereafter, slid along the coupling axis X relative to the separate carrier body 50, the fitting raised part 62b of the engaging part 62 is fitted into the sliding recessed part 53b of the engaged part 53. Also, the locked claw part 62c is locked onto the locking claw part 53c. The carrier cover 60 is thereby fixed to the separate carrier body 50. The entire circumference of the wire group 21 (see FIG. 4) is thereby covered by the separate carrier 22.

### Effect of the Embodiment

Next, the effect of the above embodiment will be described.
(1) The carrier cover 60 has the engaging part 62 that is fixed by being slid along the coupling axis X with respect to the engaged part 53 of the separate carrier body 50, thus enabling looseness of the carrier cover 60 in the direction along the coupling intersecting axis Y to be suppressed. That is, with a configuration in which the separate carrier body 50 has a locking claw that protrudes along the coupling intersecting axis Y and is locked in a locking hole of the carrier cover 60, for example, the carrier cover 60 tends to be loose in the direction along the coupling intersecting axis Y. In comparison, such looseness of the carrier cover 60 in the direction along the coupling intersecting axis Y can be made less likely. In other words, the amount of looseness of the carrier cover 60 along the coupling intersecting axis Y with respect to the separate carrier body 50 can be reduced. For example, vibration of the carrier cover 60 with respect to the separate carrier body 50 can thereby be suppressed, which in turn enables the occurrence of abnormal noise to be suppressed.
(2) In the present embodiment, the carrier cover 60 is fixed to the separate carrier body 50 due to the insertion raised part 62a being inserted into the insertion recessed part 53a along the coupling intersecting axis Y, and, further, the fitting raised part 62b being fitted into the sliding recessed part 53b along the coupling axis X. With this configuration, given that the fitting raised part 62b is fitted into the sliding recessed part 53b along the coupling axis X, looseness of the carrier cover 60 in the direction along the coupling intersecting axis Y can be suppressed.
(3) The insertion raised part 62a has the inclined surface 62d that is distanced further from the bottom surface of the insertion recessed part 53a proceeding toward the distal end thereof, thus facilitating the task of inserting the insertion raised part 62a into the insertion recessed part 53a. That is, catching of the insertion raised part 62a when inserting the insertion raised part 62a into the insertion recessed part 53a can be suppressed due to the inclined surface 62d.
(4) The carrier cover 60 has the pair of inner walls 63 respectively opposing the inner surfaces of the pair of side walls 52, and thus, for example, excessive looseness of the carrier cover 60 in the direction along the parallel arrangement axis Z on which the pair of side walls 52 are arranged can be suppressed.

### Modifications

The above embodiment can be implemented in modified form as follows. The above embodiment and the following modifications can be implemented in combination to the extent that no technical inconsistencies arise.

The engaging part 62 provided on the carrier cover 60 of the above embodiment may be changed to any other configuration in which the engaging part 62 is fixed by being slid along the coupling axis X with respect to the engaged part 53 of the separate carrier body 50. Note that the configuration of the engaged part 53 can, of course, also be changed.

For example, in the above embodiment, the engaging part 62 has the fitting raised part 62b that is fitted into the sliding recessed part 53b along the coupling axis X, but may be changed to any other configuration that is able to suppress looseness of the carrier cover 60 in the direction along the coupling intersecting axis Y.

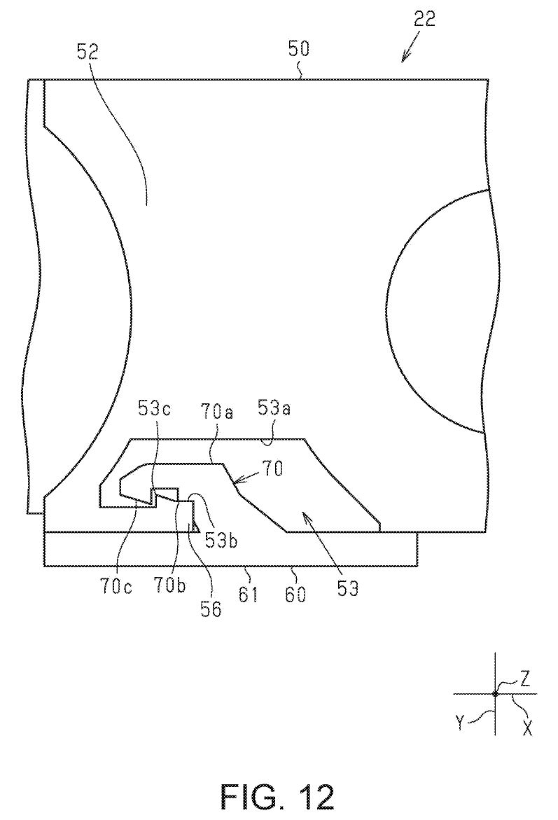

Specifically, for example, as shown in FIG. 12, a configuration may be adopted in which an engaging part 70 has an insertion raised part 70a and a fitted raised part 70b. This insertion raised part 70a protrudes from the plate-shaped part 61 in a manner insertable into the insertion recessed part 53a. Also, due to the fitted raised part 70b extending along the coupling axis X from the insertion raised part 70a, a residual wall 56 that is formed between the distal end (lower edge in FIG. 12) of each of the side walls 52 and the sliding recessed part 53b is insertable between the fitted raised part 70b and the plate-shaped part 61. Also, a locked claw part 70c that is lockable onto the locking claw part 53c is formed in the fitted raised part 70b.

By adopting such a configuration, the carrier cover 60 is fixed to the separate carrier body 50 due to the insertion raised part 70a being inserted into the insertion recessed part 53a along the coupling intersecting axis Y, and, further, the residual wall 56 being fitted between the fitted raised part 70b and the plate-shaped part 61. With this configuration, given that the residual wall 56 is fitted between the fitted raised part 70b and the plate-shaped part 61 along the coupling axis X, looseness of the carrier cover 60 in the direction along the coupling intersecting axis Y can be suppressed.

In the above embodiment, the insertion raised part 62a has the inclined surface 62d that is distanced further from the bottom surface of the insertion recessed part 53a proceeding toward the distal end thereof, but the present disclosure is not limited thereto, and a configuration may be adopted in which the inclined surface 62d is not provided.

In the above embodiment, the carrier cover 60 has the pair of inner walls 63 respectively opposing the inner surfaces of the pair of side walls 52, but the present disclosure is not limited thereto, and a configuration may be adopted in which the inner walls 63 are not provided.

The locking claw part 53c in the above embodiment may be provided at other positions in the separate carrier body 50. Also, the locked claw part 62c may be provided at any other position in the carrier cover 60 that corresponds to the position of the locking claw part 53c.

In the above embodiment, the width of the fitting raised part 62b along the coupling intersecting axis Y is set to be the same as the width of the sliding recessed part 53b along the coupling intersecting axis Y, but the present disclosure is not limited thereto.

For example, a configuration may be adopted in which the width of the fitting raised part 62b along the coupling intersecting axis Y is slightly larger than the width of the sliding recessed part 53b along the coupling intersecting axis Y, and the fitting raised part 62b is press fit into the sliding recessed part 53b. Also, for example, the width of the fitting raised part 62b along the coupling intersecting axis Y may be slightly smaller than the width of the sliding recessed part 53b along the coupling intersecting axis Y, that is, within a range in which the amount of looseness is reduced over conventional technologies.

In the above embodiment, as the separate carriers 22, two types of separate carriers 22 with different rotatable angles, namely, the first separate carrier 22A and the second separate carrier 22B, are used, but the present disclosure is not limited thereto. For example, as the separate carriers 22, a single separate carrier 22 with a certain rotatable angle may be used, or three or more types of separate carriers 22 with different rotatable angles may be used.

In the above embodiment, the wiring harness 20 is provided with the rubber boot 23, but the present disclosure is not limited thereto, and a configuration may be adopted in which the rubber boot 23 is not provided. That is, a configuration may be adopted in which the separate carriers 22 are exposed to the outside.

The embodiments disclosed herein are to be considered in all respects as illustrative examples, and the present disclosure is not limited to these illustrative examples. That is, the scope of the disclosure is indicated by the claims, and all changes that come within the meaning and range of equivalency of the claims are intended to be embraced therein.

What is claimed is:

1. A wiring harness comprising:
a wire group that is configured to be routed from a vehicle body to a sliding door that is openable and closeable with respect to the vehicle body; and
a plurality of separate carriers that cover the wire group with the separate carriers rotatably coupled to each other and arranged adjacently along a coupling axis parallel to a direction in which the wire group extends, wherein:
each separate carrier of the separate carriers includes:
a U-shaped separate carrier body that is open along a coupling intersecting axis intersecting the coupling axis due to having a back wall and a pair of side walls that oppose each other and that extend from both ends of the back wall; and
a carrier cover having a plate-shaped part that blocks an opening of the separate carrier body,
the separate carrier body has an engaged part on each of the pair of side walls, and
the carrier cover has an engaging part that is fixed by being slid along the coupling axis with respect to the engaged part.

2. The wiring harness according to claim 1, wherein:
the engaged part includes:
an insertion recessed part that is recessed from an outer side along a parallel arrangement axis on which the pair of side walls are arranged and extending along the coupling intersecting axis from a distal end of each of the pair of side walls; and
a sliding recessed part that extends along the coupling axis from the insertion recessed part in a bending manner, and
the engaging part includes:
an insertion raised part that protrudes from the plate-shaped part in a manner insertable into the insertion recessed part; and
a fitting raised part that extends along the coupling axis from the insertion raised part in a manner fittable into the sliding recessed part.

3. The wiring harness as according to claim 2,
wherein the insertion raised part has an inclined surface that is distanced further from a bottom surface of the insertion recessed part proceeding toward a distal end of the insertion recessed part.

4. The wiring harness according to claim 1,
wherein the carrier cover has a pair of inner walls respectively opposing inner surfaces of the pair of side walls.

5. The wiring harness according to claim 1, wherein:
the engaged part includes:
an insertion recessed part that is recessed from an outer side along a parallel arrangement axis on which the pair of side walls are arranged and extending along the coupling intersecting axis from a distal end of each of the pair of side walls; and
a sliding recessed part that extends along the coupling axis from the insertion recessed part in a bending manner, and
the engaging part includes:
an insertion raised part that protrudes from the plate-shaped part in a manner insertable into the insertion recessed part; and
a fitted raised part that extends along the coupling axis from the insertion raised part, with a residual wall formed between a distal end of each of the pair of side walls and the sliding recessed part being fittable between the fitted raised part and the plate-shaped part.
